(19) United States
(12) Patent Application Publication
(10) Pub. No.: US 2016/0052013 A1
(43) Pub. Date: Feb. 25, 2016

(54) CURTAIN COATING MACHINE AND CURTAIN COATING METHOD

(71) Applicants: Hiroki SOMADA, Tokyo (JP); Kazuhisa YAMAMOTO, (US)

(72) Inventors: Hiroki SOMADA, Shizuka (JP); Kazuhisa YAMAMOTO, Shizuoka (JP)

(73) Assignee: RICOH COMPANY, LTD, Tokyo (JP)

(21) Appl. No.: 14/779,128

(22) PCT Filed: Mar. 6, 2014
(86) PCT No.: PCT/JP2014/056594

§ 371 Date: Sep. 22, 2015

(30) Foreign Application Priority Data
Mar. 29, 2013 (JP) 2013-072738

(51) Int. Cl. B05C 11/00; B05D 1/30; B05C 5/00

(52) U.S. Cl. CPC B05C 11/00; B05C 5/005; B05D 1/305

(57) ABSTRACT

Provided is a curtain coating machine, including at least: a curtain coating member including a discharging port from which a coating liquid is discharged in a curtain shape; a discharging width regulating member provided in the discharging port and regulating the discharging width of the coating liquid discharged in a curtain shape; a drop-off preventing member preventing the discharging width regulating member from dropping off from the discharging port; a fixing member fixing the drop-off preventing member; a close contact member movable on the fixing member and closely contacting the drop-off preventing member, and via the drop-off preventing member, preventing the coating liquid from leaking in a discharging direction from where the discharging width regulating member is provided in the discharging port; and a guide member provided detachably on the fixing member and guiding width-direction both edges of the coating liquid discharged from the discharging port in a curtain shape.

### TECHNICAL FIELD

The present invention relates to a slot curtain coating machine and a curtain coating method.

### BACKGROUND ART

There is proposed a slot curtain coating machine including a means that, without changing the discharging width of a coating liquid to be discharged from a slot die, but with a curtain-film-separating liquid-receptacle pan inserted within the width of a falling curtain film and including curtain film separating plates, changes the curtain coating width by withdrawing the coating liquid from both edges of the curtain film and separating the withdrawn portions at both edges from the central coating portion of the curtain film to thereby make the width of the portion to fall on a support member smaller than the width of the coating liquid when it is discharged (see PTL 1 and PTL 2).

However, the proposed technique needs to withdraw the coating liquid, and needs circulating equipment to recycle the withdrawn coating liquid. To circulate the coating liquid, it is necessary to defoam the coating liquid. When the viscosity of the coating liquid is high or when the viscosity of the coating liquid may be greatly depressed by shear, it is very difficult to defoam the coating liquid. When it is unable to remove foam from the coating liquid, there may be a problem that coating deficiency occurs due to the foam in the coating liquid. When the production is continued by withdrawing and circulating the coating liquid, there may be a problem that the solid content of the coating liquid alters and degrades the quality of the coated film. For example, when the coating liquid is an acrylic emulsion having a high solid content, a solidified product of the coating liquid may segregate. When a solidified product segregates, not only may coating deficiency occur, but also the curtain film may crack or tear. The torn curtain film may contaminate the surroundings, or may cause an error when the film is wound due to uneven film thickness, which may halt the production in the worst case.

Such a curtain coating machine as shown in FIG. 1 is placed on the market, which includes as the curtain film coating width changing means, a structure in which a deckle and an edge guide are integrated. This curtain coating machine can easily change the coating width of a curtain film without withdrawal of the coating liquid, which has been the problem of the inventions described in PTL 1 and PTL 2.

However, because the deckle 201 as a discharging width regulating member and the edge guide 202 as a guide member are integrated, the curtain coating machine shown in FIG. 1 causes the coating liquid to fall in a comb-like shape from the discharging port of the slot die at the start of a coating operation at which the flow rate of the coating liquid is low. In this case, the coating liquid is swung left and right easily due to external disturbance such as wind, changes in the flow rate of the coating liquid, etc. By swinging, the coating liquid may adhere to a flow-down surface of the edge guide, and as is, may flow down the flow-down surface to thereby contaminate the flow-down surface partially or entirely. Contamination of the flow-down surface hinders flowing down of edge guide facilitating water, to thereby slow down the falling speed of the edge portion of the curtain film and cause a problem that the uniformity of the film thickness is poor.

Furthermore, when a curtain film is formed while the edge guide remains contaminated, the curtain film may not fall vertically but curve, which may produce a streak that draws an arc from where the curtain film contacts the edge guide to where the curtain film collides on the support member. The curtain film may be undulated at the colliding portion to thereby cause a problem that the uniformity of the film thickness is poor.

Moreover, while a coating operation is not actuated, the slot of the slot die is cleaned with a cleaning film having a strip shape that is inserted into the slot. Since the deckle 201 and the edge guide 202 are integrated in the curtain coating machine shown in FIG. 1, it is difficult to clean the edge guide and therearound. Therefore, during the cleaning, the coating liquid, a cleaning liquid, etc. may spatter and contaminate the edge guide.

Hence, it is requested to provide a slot curtain coating machine that can easily change the curtain film coating width without contaminating an edge guide provided as a guide member with a coating liquid, etc.

### CITATION LIST

### Patent Literature

| PTL 1 | U.S. Pat. No. 6,709,517 |
|---|---|
| PTL 2 | Japanese Patent Application Laid-Open (JP-A) No. |
| | 2009-18285 |

### SUMMARY OF INVENTION

### Technical Problem

The present invention relates to a slot curtain coating machine that can easily change the curtain film coating width without contaminating an edge guide provided as a guide member with a coating liquid, etc.

### Solution to Problem

As means for solving the problems described above, a curtain coating machine of the present invention includes at least:

a curtain coating member including a discharging port from which a coating liquid is discharged in a curtain shape;

a discharging width regulating member provided in the discharging port and configured to regulate a discharging width of the coating liquid to be discharged in the curtain shape;

a drop-off preventing member configured to prevent the discharging width regulating member from dropping off from the discharging port;
a fixing member configured to fix the drop-off preventing member;

a close contact member provided movably on the fixing member, and configured to closely contact the drop-off preventing member, and via the drop-off preventing member, prevent the coating liquid from leaking in a discharging direction from a region in the discharging port where the discharging width regulating member is provided; and

a guide member provided detachably on the fixing member and configured to guide width-direction both edges of the coating liquid discharged from the discharging port in the curtain shape.

### Advantageous Effects of Invention

The present invention can provide a slot curtain coating machine that can solve the conventional problems described above, and can easily change the curtain film coating width without contaminating an edge guide provided as a guide member with a coating liquid, etc.

### BRIEF DESCRIPTION OF DRAWINGS

FIG. 1 is a schematic diagram showing an example conventional slot curtain coating machine.

FIG. 2 is a front elevation of an example slot die of a curtain coating machine of the present invention.

FIG. 3 is a one-side enlarged front elevation showing an example slot die of a curtain coating machine of the present invention.

FIG. 4 is a one-side enlarged front elevation showing an example slot die of a curtain coating machine of the present invention, where an edge guide is detached.

FIG. 5 is a one-side enlarged front elevation showing an example slot die of a curtain coating machine of the present invention, where an edge guide is retracted in a width direction.

FIG. 6 is a schematic cross-sectional diagram showing an example slot die of a curtain coating machine of the present invention.

FIG. 7 is a schematic cross-sectional diagram showing an example slot die of a curtain coating machine of the present invention, where a close contact member and an edge guide are removed.

FIG. 8 is a schematic diagram showing an example case where a discharging port of a slot die of a curtain coating machine is inclined to a horizontal direction or to a direction opposite from a support member with respect to the horizontal direction.

FIG. 9 is a schematic diagram showing an example case where a discharging port of a slot die of a curtain coating machine is inclined to a horizontal direction or to a direction opposite from a support member with respect to the horizontal direction.

FIG. 10 is a schematic diagram showing an example case where a slot die of a curtain coating machine is lifted up and down.

FIG. 11 is a schematic diagram showing an example case where a slot die of a curtain coating machine is lifted up and down.

FIG. 12 is a schematic diagram showing an example state in which a coating liquid is discharged so as to form a curtain film.

FIG. 13 is a schematic diagram showing an example state in which a coating liquid is discharged in so small an amount as not to form a curtain film.

FIG. 14 is a schematic diagram showing an example in which an edge guide is moved away from its position during coating in a coating width direction.

FIG. 15 is a partial expanded diagram showing an example of a discharging port portion of a slot die and a discharging width regulating member.

FIG. 16A is a partial expanded diagram showing another example of a discharging port portion of a slot die and a discharging width regulating member.

FIG. 16B is a partial expanded diagram showing another example of a discharging port portion of a slot die and a discharging width regulating member.

FIG. 17 is a partial expanded diagram showing another example of a discharging port portion of a slot die and a discharging width regulating member.

### DESCRIPTION OF EMBODIMENTS

### Curtain Coating Machine and Curtain Coating Method

A curtain coating machine of the present invention includes at least a curtain coating member, a discharging width regulating member, a drop-off preventing member, a fixing member, a close contact member, and a guide member, and further includes other members according to necessity.

A curtain coating method of the present invention is performed with the curtain coating machine of the present invention.

The curtain coating machine and the curtain coating method of the present invention will be explained below in detail.

### <Curtain Coating Member>

The curtain coating member is a member including a discharging port from which a coating liquid is discharged in a curtain shape.

The curtain coating member is not particularly limited and may be appropriately selected according to the purpose, as long as it is a member including a discharging port from which a coating liquid is discharged in a curtain shape. However, a preferable example thereof is a slot die.

### —Coating Liquid—

The coating liquid is delivered from a coating liquid stock tank to the slot die through a pump, a filter, a liquid temperature regulating device, a branch valve, etc., and coated on a support member.

The coating liquid is not particularly limited and may be appropriately selected according to the purpose. Examples thereof include acrylic emulsion, thermosensitive recording material liquid, thermal transfer ribbon coating liquid, aqueous coating liquid, and solvent coating liquid. One of these may be used alone, or two or more of these may be used in combination.

The viscosity of the coating liquid is not particularly limited and may be appropriately selected according to the purpose. However, it is preferably from 1 mPa·s to 2,000 mPa·s at 25° C. When the viscosity is less than 1 mPa·s, the liquid may drop from the slit of the slot die when, for example, coating is suspended. When the viscosity is greater than 2,000 mPa·s, it may be hard for the air bubbles in the coating liquid to escape. The air bubbles in the coating liquid may cause deficiency or raise the pressure for discharging the coating liquid to thereby impose a greater load on the liquid delivering pump. Therefore, the liquid feeding system may be required to have pressure resistance.

The surface tension of the coating liquid is not particularly limited and may be appropriately selected according to the purpose. However, it is preferably from 20 mN/m to 40 mN/m. When the surface tension is less than 20 mN/m, the surface tension of the film itself may become weak to make the film be weakly tensioned and allow the film to easily distort and swing due to external disturbance by wind. On the other hand, when the surface tension is greater than 40 mN/m, the curtain film may tear upward.

As the surface tension, static surface tension can be measured with, for example, a FACE automatic surface tensiometer (manufactured by Kyowa Interface Science Co., Ltd.), according to platinum plate method.

Dynamic surface tension in a curtain coating method can be measured according to, for example, a method of calculating a dynamic surface tension based on the angle at which a curtain film cracks when a needle-shaped object is inserted into the film, which is disclosed in “A study of the behaviour of a thin sheet of moving liquid” D. R. Brown. Journal of Fluid Mechanics 10, pp. 297-305. 1961, etc.

### —Coating Liquid Discharging Port—

The cross-sectional shape of a discharging port of the coating liquid is not particularly limited and may be appropriately selected according to the purpose. However, it is preferably a quadrangular shape.

The size of the coating liquid discharging port is not particularly limited and may be appropriately selected according to the purpose. However, the clearance is preferably from 0.2 mm to 0.5 mm.

The clearance (slit) has a function of making the coating liquid uniform in the width direction. The size thereof varies according to the size and shape of a manifold of the slot die, and the distance from the manifold to the slit exit, and according to the flow rate and viscosity of the coating liquid, as described in, for example, “Slot Coating: Fluid mechanics and die design, Sartor, Luigi, Ph.D. University of Minnesota, 1990”.

The material of the discharging port is not particularly limited and may be appropriately selected according to the purpose. Preferable examples thereof include stainless steel (SUS) and aluminum, or hard chromium-plated product of these.

Even when the coating liquid contains a resin, it is preferable to use metal as the material of the discharging port, because it is possible to prevent clogging.

### —Discharging Mechanism—

A discharging mechanism for discharging the coating liquid is not particularly limited and may be appropriately selected according to the purpose. However, it is preferably a slot die.

The slot die is used when coating one or two layers of coating liquid. Because the discharging direction is the direction of gravitational force (downward), liquid dropping may occur when the viscosity of the coating liquid is low, or air bubbles in the coating liquid may remain in the manifold of the slot die.

Compared with a slide die, the slot die has a higher coating liquid discharging speed, and hence, the slot curtain coating method is less likely to cause the curtain film to tear upward, when considering the upward tearing mechanism of a curtain film of tearing upward when the dynamic surface tension of the coating liquid is grater in the balance between the dynamic surface tension of the coating liquid and the dynamic pressure (inertia force) of the coating liquid when falling. Furthermore, the slot die does not have such an open space as the slide down surface of a slide die, it can be easily cleaned, and the amount of cleaning liquid such as water used for cleaning can be saved. Further, when the viscosity of the coating liquid is high, the slot die can be suspended easily in the middle of the operation.

### —Flow Rate of Coating Liquid—

The flow rate of the coating liquid is not particularly limited and may be appropriately selected according to the purpose, as long as it can form a curtain film.

The discharging port surface of the curtain coating member preferably has a flat portion having a width of from 1 mm to 2 mm. When the width of the flat portion is less than 1 mm, it may be difficult for the close contact member and the fixing member to press a sheet provided as the drop-off preventing member onto the discharging port of the slot die.

### <Discharging Width Regulating Member>

The discharging width regulating member is a member provided in the discharging port and configured to regulate the discharging width of the coating liquid to be discharged in a curtain shape.

The discharging width regulating member is not particularly limited and may be appropriately selected according to the purpose, as long as it can be provided in the discharging port and can regulate the discharging width of the coating liquid to be discharged in a curtain shape. However, the discharging width regulating member is preferably a deckle.

The size, shape, structure, material, etc. of the deckle are not particularly limited and may be appropriately selected according to the purpose.

Examples of the shape of the deckle include sheet shape, film shape, and plate shape. For example, when the discharging port surface of the slot die 1 has a flat portion, a sheet-shaped deckle 10 may be used as shown in FIG. 15.

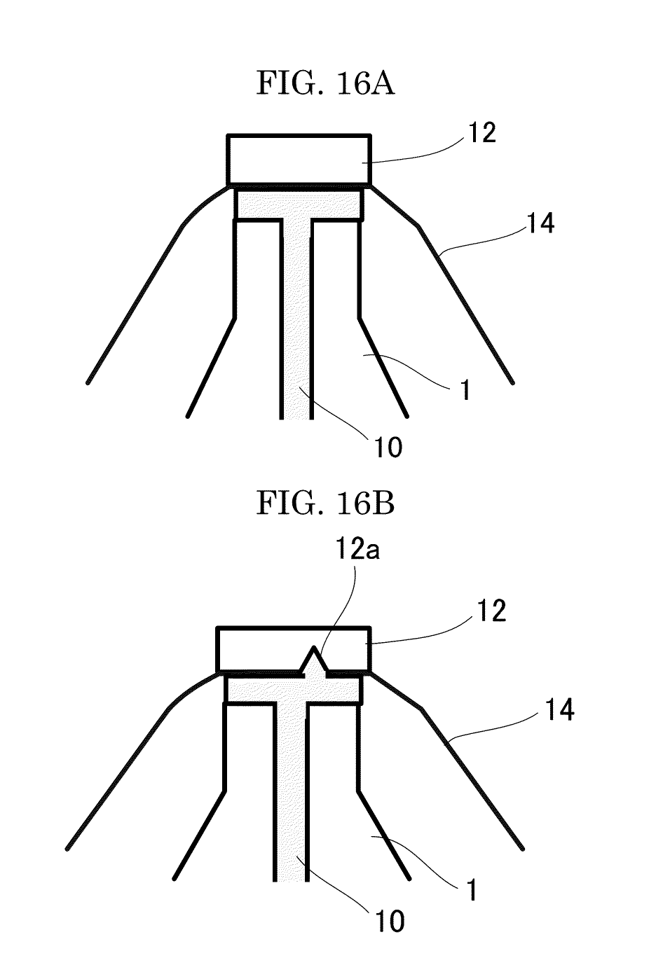

Further, when the discharging port surface of the slot die 1 has a flat portion, it is advantageous if the deckle 10 has a T-letter cross-sectional shape at the leading end thereof as shown in FIG. 16A, because this makes the deckle 10 easier to handle.

FIG. 16B shows another case of FIG. 16A in which the fixing member 12 has a notch 12a. This is advantageous because this makes it easier for the fixing member 12 to support the deckle 10.

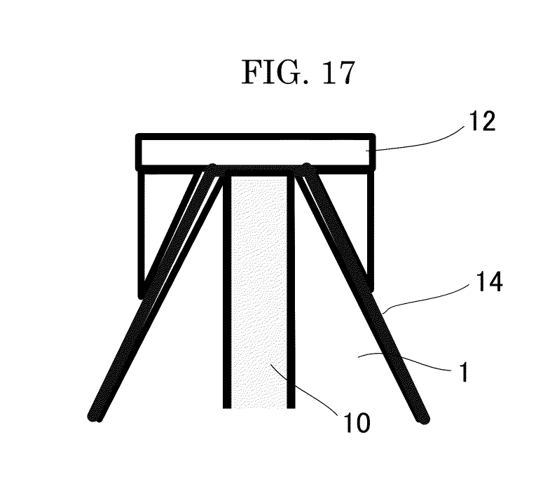

When the slot die 1 tapers toward the leading end thereof and the discharging port surface has a very small flat portion as shown in FIG. 17, the shape of the fixing member 12 may be made to conform to the shape of the leading end of the slot die 1, which makes it possible to obtain a similar effect to that described above.

In FIG. 15, FIG. 16A, FIG. 16B, and FIG. 17, the reference sign 14 denotes a sheet provided as the drop-off preventing member.

When the discharging port surface of the slot die has no flat portion, the shape of the leading end of the slot die may be made equal to the cross-sectional shape of the deckle, which makes it possible to obtain similar effects to those described above.

Examples of the material of the deckle include metal such as stainless steel, aluminum, and iron, or hard chromium-plated product of these, and resin such as polytetrafluoroethylene (Teflon (Registered Trademark)), polyethylene terephthalate (PET) resin, ABS resin, FRP, and nylon.

The thickness of the deckle is not particularly limited and may be appropriately selected according to the purpose, as long as it is smaller than the clearance of the slit of the slot die.

The length of the deckle is not particularly limited and may be appropriately selected according to the purpose, and can be adjusted according to, for example, the length of the slot die.

In the present invention, it is preferable to satisfy the following formula of 85%≦(A/B)×100≦95%, where A represents the thickness of the deckle provided as the discharging width regulating member, and B represents the width of the discharging port of the slot die provided as the curtain coating member.

When the ratio [(A/B)×100] is less than 85%, it becomes likely for liquid dropping to occur from the discharging port of the slot die in a non-coating portion (in a deckle insertion portion). When the ratio is greater than 95%, it becomes difficult to insert the deckle into the slot die.

### <Drop-Off Preventing Member>

The drop-off preventing member is a member configured to prevent the discharging width regulating member from dropping off from the discharging port.

The drop-off preventing member is not particularly limited and may be appropriately selected according to the purpose, as long as it is a member that can prevent the discharging width regulating member from dropping off from the discharging port. However, the drop-off preventing member is preferably a sheet.

The size, shape, structure, material, etc. of the sheet are not particularly limited and may be appropriately selected according to the purpose.

The material of the sheet is not particularly limited and may be appropriately selected according to the purpose. Examples thereof include polytetrafluoroethylene (Teflon (Registered Trademark)), polyethylene terephthalate (PET) resin, ABS resin, FRP, and nylon.

The thickness of the sheet is not particularly limited and may be appropriately selected according to the purpose. However, it is preferably 25 μm or greater, and more preferably from 25 μm to 200 μm. When the thickness is less than 25 μm, the sheet is difficult to handle, is likely to wrinkle, and may not be able to prevent leakage of the coating liquid from the discharging port of the slot die. When the thickness is greater than 200 μm, the sheet may not be able to deform well when covering the discharging port of the slot die and may cause liquid leakage.

The length of the sheet is not particularly limited and may be appropriately selected according to the purpose. However, it is preferably such a length as to allow the sheet to serve as a liquid receptacle when a small amount of coating liquid leaks from the discharging port of the slot die and to prevent the surroundings from being contaminated by the coating liquid. Further, it is preferable if the outer ends of the sheet are more outward than the ends of the fixing member described below, because this may prevent the fixing from being damaged by contamination when a small amount of coating liquid leaks from the discharging port of the slot die and may make it easier to collect the coating liquid

It is preferable if both ends of the sheet provided as the drop-off preventing member curve toward the manifold of the slot die, because this may make it easier for the sheet to serve as a liquid receptacle when a small amount of coating liquid leaks from the discharging port of the slot die and to prevent the surroundings from being contaminated.

### <Fixing Member>

The fixing member is a member configured to fix the drop-off preventing member.

The fixing member is not particularly limited and may be appropriately selected according to the purpose, as long as it is a member that can fix the drop-off preventing member. It is preferable that the size of a surface thereof on which the drop-off preventing member is fixed be larger than the clearance of the discharging port of the slot die.

The shape, size, structure, material, etc. of the fixing member are not particularly limited and may be appropriately selected according to the purpose.

Examples of the shape of the fixing member include prismatic column shape, substantially cylindrical shape, plate shape, and bar shape.

The material of the fixing member is preferably a material softer than the material of the slot die, in terms of preventing the fixing member from denting the discharging port of the slot die. Preferable examples of the material include polytetrafluoroethylene (Teflon (Registered Trademark)), polyethylene terephthalate (PET) resin, ABS resin, FRP, nylon, and aluminum.

The fixing member may be integrated with or separate from the close contact member described below, as long as the fixing member is flat on at least one surface thereof, and the size of this flat surface is larger than the clearance of the slot of the slot die.

When the fixing member is integrated with the close contact member, it takes some time to press the sheet with the fixing member when setting the fixing member on the slot die, but this is not problematic in practical use.

When the fixing member is separate from the close contact member, it is comparatively easy to press the sheet with the fixing member when setting the fixing member on the slot die. When the fixing member and the close contact member are separate, there is another advantage that even when the surface of the fixing member with which to press the sheet is damaged, it is only necessary to polish or exchange only the fixing member.

### <Close Contact Member>

The close contact member is a member that is provided movably on the fixing member, and configured to closely contact the drop-off preventing member, and via the drop-off preventing member, prevent the coating liquid from leaking in a discharging direction from a region in the discharging port where the discharging width regulating member is provided.

A member for applying a force to the close contact member in order to press the sheet with the fixing member is not particularly limited and may be appropriately selected according to the purpose. Examples thereof include pneumatic cylinder, hydraulic cylinder, electric cylinder, and pressing screw.

The shape, size, structure, material, etc. of the close contact member are not particularly limited and may be appropriately selected according to the purpose.

The material of the close contact member is not particularly limited and may be appropriately selected according to the purpose. Examples thereof include stainless steel (SUS) and aluminum or hard chromium-plated product of these, polytetrafluoroethylene (Teflon (Registered Trademark)), polyethylene terephthalate (PET) resin, ABS resin, FRP, and nylon.

### <Guide Member>

The guide member is a member that is provided detachably on the fixing member, and configured to guide width-direction both edges of the coating liquid discharged from the discharging port in a curtain shape.

The guide member is not particularly limited and may be appropriately selected, as long as it is provided detachably on the fixing member and can guide width-direction both edges of the coating liquid discharged from the discharging port in a curtain shape. However, the guide member is preferably an edge guide.

It is preferable that the guide member be provided movably on the leading end of the close contact member, because this makes it possible for the edge guide to be moved away for preventing an edge guide facilitating water flow-down surface of the edge guide from being contaminated by the coating liquid.

The shape, size, structure, material, etc. of the edge guide are not particularly limited and may be appropriately selected according to the purpose.

The edge guide is not particularly limited and may be appropriately selected according to the purpose. Examples thereof include the edge guide described in JP-A No. 2012-35210, which has a structure including a slit from which the facilitating water is discharged vertically downward, and a flow down surface along which the facilitating water flows down uniformly.

The slit from which the facilitating water is discharged has a quadrangular cross-sectional shape, and the flow down surface has a side wall along which the facilitating water flows down uniformly.

The material of the slit and the flow down surface of the facilitating water is not particularly limited and may be appropriately selected, as long as it is a material that would not be eroded by an inner facilitating liquid. However, the material is preferably metal in terms of preventing clogging with the coating liquid, etc.

The facilitating liquid is not particularly limited and may be appropriately selected according to the purpose. Examples thereof include water, liquid obtained by adding surfactant to water, and main solvent of the coating liquid.

### <Support Member>

The support member is not particularly limited and may be appropriately selected according to the purpose, as long as it can support the coating liquid.

The shape, structure, and size of the support member are not particularly limited and may be appropriately selected.

Examples of the support member include paper liner, base paper, artificial paper, polyethylene terephthalate (PET) film, etc.

### <Other Members>

The other members are not particularly limited and may be appropriately selected according to the purpose. Examples thereof include a conveying member.

The conveying member is a member configured to convey the support member. Examples thereof include a conveyor roller, and conveyor.

### —Applications—

The curtain coating machine and the curtain coating method of the present invention are not particularly limited and may be appropriately selected according to the purpose. They can be preferably used for manufacturing, for example, silver halide photographic sensitive material, magnetic recording material, pressure-sensitive recording paper, thermosensitive recording paper, adhesive label, art paper, coat paper, and inkjet recording sheet.

The curtain coating machine and the curtain coating method of the present invention will be explained below in detail with reference to the drawings. The following explanation is an example of the present invention, and the scope of the present invention is not limited thereto.

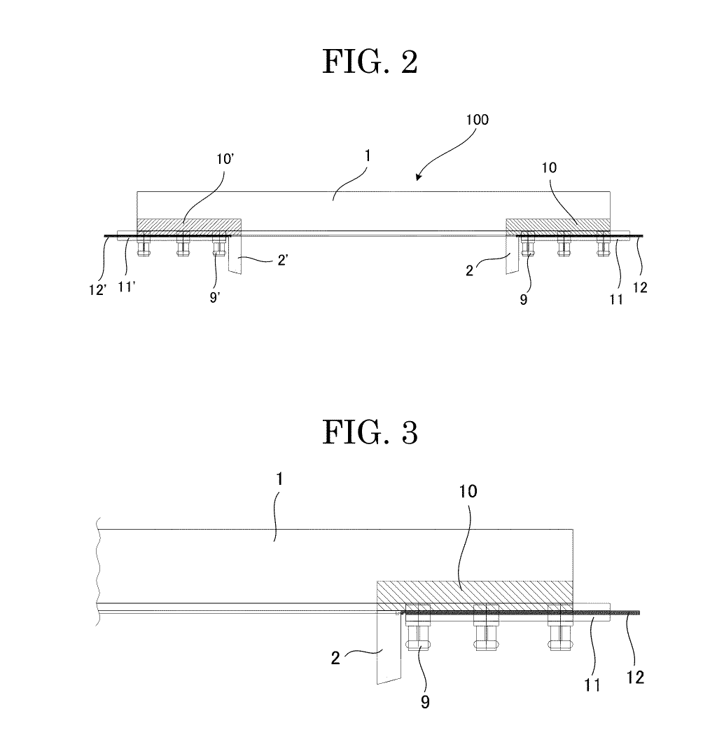

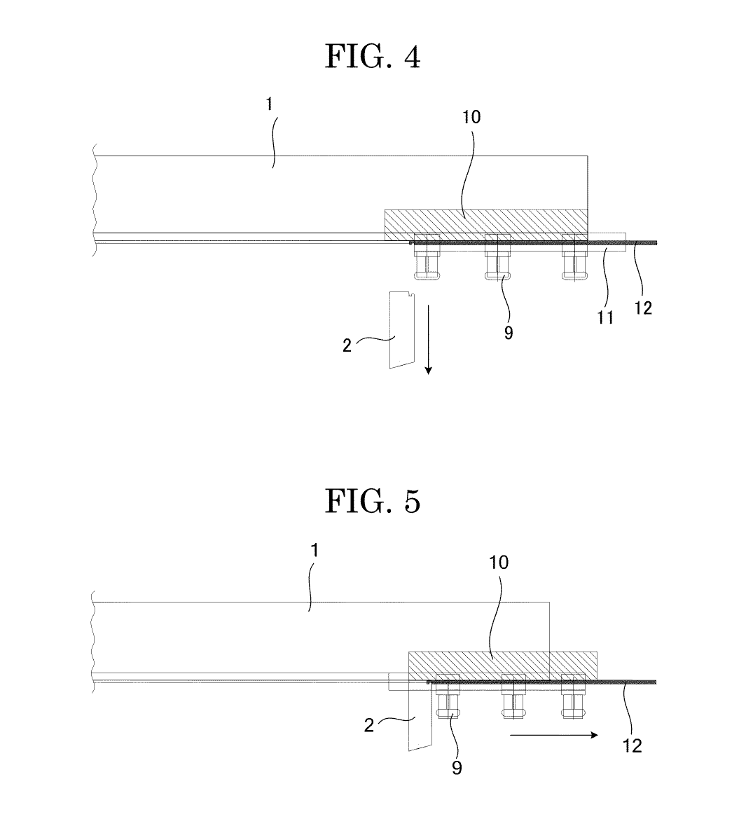

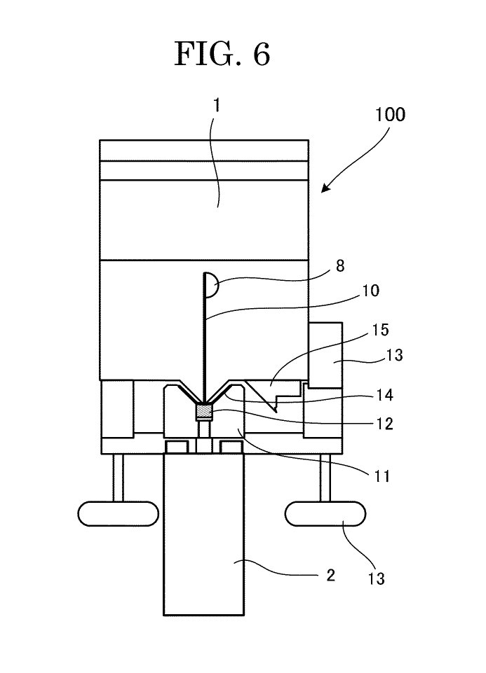

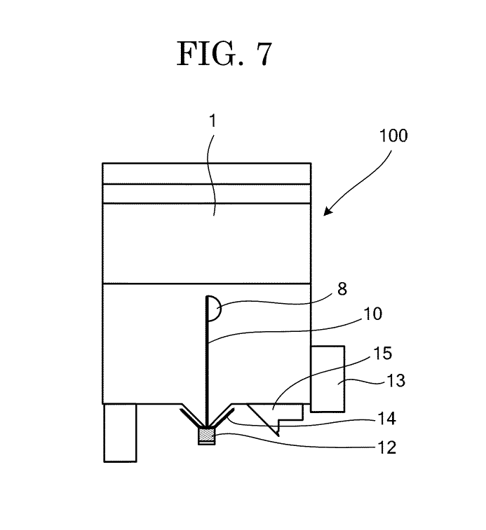

FIG. 2 is a front elevation showing an example slot die of a slot curtain coating machine of the present invention. FIG. 3 is a front elevation showing one side of FIG. 2 in enlargement. FIG. 4 is a front elevation showing one side of FIG. 2 in enlargement, where the edge guide is detached. FIG. 5 is a front elevation showing one side of FIG. 2 in enlargement, where the edge guide is retracted in the width direction. FIG. 6 is a schematic cross-sectional diagram showing an example slot die of a slot curtain coating machine of the present invention. FIG. 7 is a schematic cross-sectional diagram showing an example slot die of a curtain coating machine of the present invention, where the close contact member and the edge guide are removed.

The curtain coating machine 100 shown in FIG. 2 to FIG. 7 includes a slot die 1 as the curtain coating member, an edge guide 2 as the guide member, a sheet 14 as the drop-off preventing member, a close contact member 11, a fixing member 12, and a deckle 10 as the discharging width regulating member. The reference sign 9 in FIG. 2 denotes bolts for attaching the close contact member 11 onto the slot die 1. The reference sign 13 in FIG. 6 denotes a close contact member receptacle, the reference sign 15 denotes a liquid flow down guide plate, and the reference sign 8 denotes a manifold.

When coating, the slot die 1 as the curtain coating member is set such that the discharging port of the slot die faces the direction of gravitational force (downward). In this state, coating is performed stably. The material of the slot die 1 is stainless steel.

The discharging port plane of the slot die 1 as the curtain coating member has a flat portion having a width of from 1 mm to 2 mm. The length of the discharging port in the width direction is 600 mm.

As the deckle 10, a sheet-shaped material having a thickness of 0.488 mm and a length of 75 mm and made of polyethylene terephthalate (PET) is used.

With the deckle 10 inserted into both ends of the slot die 1, the coating width of the coating liquid is regulated to 450 mm from the width direction length of the discharging port of 600 mm.

As the sheet 14 as the drop-off preventing member, a sheet having a thickness of from 25 μm to 100 μm and a length of 30 cm and made of polyethylene terephthalate (PET) is used. Both ends of the sheet 14 are curved toward the manifold of the curtain coating member.

The material of the close contact member 11 is stainless steel.

The material of the fixing member 12 is polytetrafluoroethylene (Teflon (Registered Trademark)).

As the edge guide 2 as the guide member, the same as the edge guide described in JP-A No. 2012-35210 is used.

As the coating liquid, an acrylic emulsion adhesive [viscosity characteristic y=900x−0.26 (where x represents a shear rate (1/s), and y represents viscosity, it was 700 mPa·s when measured with a B type viscometer), static surface tension of 30 mN/m, manufactured by Saiden Chemical Industry Co., Ltd.] is used.

Next, the method for performing curtain coating and for changing the coating width of the curtain film will be explained.

First, in order to change the curtain film coating width in the curtain coating machine, the deckle 10 having a sheet shape is inserted into the discharging port of the slot die 1 as shown in FIG. 2, to regulate the width over which the coating liquid is to be discharged and change the curtain film coating width. Specifically, the deckle 10, of which length is adjusted, is inserted into the discharging port of the slot die 1 manually, and the end surface of the deckle 10 is adjusted to coincide with the side of the slot die 1. In this way, it is possible to change the curtain film coating width.

In order to prevent the liquid from being discharged from the non-discharging portions of the slot die 1 into which the deckle 10 has been inserted, as shown in FIG. 2 and FIG. 6, the discharging port of the slot die at the non-discharging portions is covered with the sheet 14, and the sheet 14 is pressed onto the discharging port with the close contact member 11 and the fixing member 12 (see FIG. 15). The pressing pressure of the close contact member 11 is not particularly limited and may be appropriately selected.

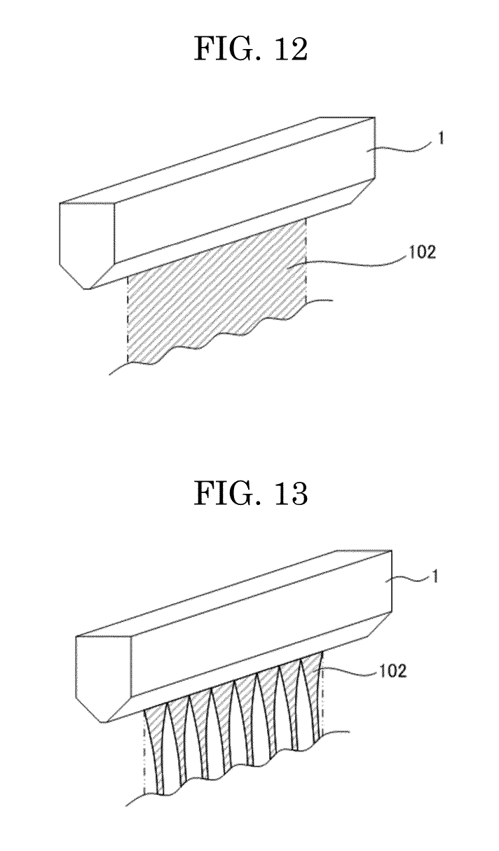

Next, FIG. 4 shows a state in which the edge guide 2 is detached from the slot die. By detaching the edge guide 2 and removing it from the region represented by the reference numeral 102 in FIG. 12 and FIG. 13 in which the coating liquid falls, it is possible to prevent the edge guide from being contaminated by spattering of the coating liquid and a cleaning liquid.

Further, by detaching and removing the edge guide 2 from the slot die 1 as shown in FIG. 4, it is possible to start the coating by preventing the curtain film flow down surface of the edge guide from being contaminated by changing the coating width.

Here, the region in which the coating liquid falls means a space formed by the thickness of a curtain film made of the coating liquid, the coating width of the curtain film made of the coating liquid, and the height of the curtain film made of the coating liquid.

Next, when changing the curtain film coating width and starting the coating, the deckle 10 is inserted into the discharging port of the slot die 1, and the discharging port of the slot die in the non-coating portions into which the sheet-shaped deckle 10 has been inserted is covered with the sheet 14, and the sheet 14 is pressed with the fixing member 12, the close contact member 11, and the upper end of the edge guide 2.

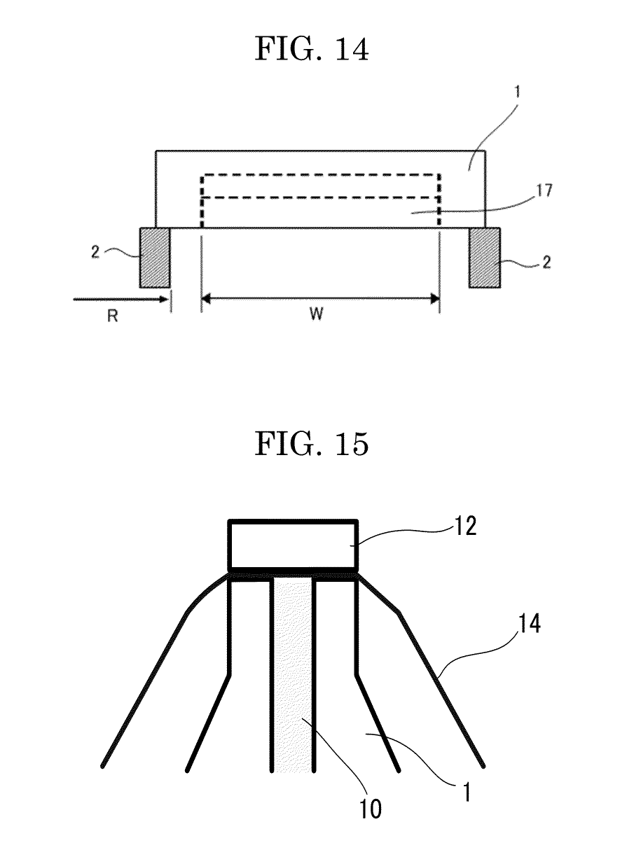

When the coating liquid before the coating is started is in a condition unable to form a curtain film, it is preferable to move the edge guide 2, the fixing member 12, and the close contact member 11 outward by several millimeters to several ten millimeters from the discharging port having the width W, as shown in FIG. 14. When an intended flow rate of coating liquid is discharged, the edge guide 2, the fixing member 12, and the close contact member 11 are immediately moved to the end of the deckle 10 to form a curtain film.

When the close contact member 11 and the fixing member 12 are one integrated member, it is possible to perform curtain coating and changing of the curtain film coating width, by pressing the sheet 14 onto the discharging port of the slot die with the integrated close contact member 11 and the edge guide 2, although not illustrated.

For changing the curtain film coating width, the edge guide 2 and the slot die 1 may be separate or integrated. However, they are preferably separate, so as not for the curtain film flow down surface of the edge guide 2 to be contaminated when the manifold 8 and the slit 110 of the slot die 1 are filled with the coating liquid.

When the coating liquid before the coating is started is in a condition unable to form a curtain film, it is preferable to move the edge guide 2, the fixing member 12, and the close contact member 11 outward from the region represented by the reference numeral 102 in FIG. 12 and FIG. 13 in which the coating liquid falls.

The region in which the coating liquid falls means a space formed by the thickness of a curtain film made of the coating liquid, the width of the curtain film made of the coating liquid, and the height of the curtain film made of the coating liquid.

A member for moving the edge guide 2, the fixing member 12, and the close contact member 11 is not particularly limited and may be appropriately selected. However, the edge guide 2 may be moved integrally with or independently from the fixing member 12 and the close contact member 11.

When they are moved integrally, it is preferable that the edge guide 2 be connected to the fixing member 12 or the close contact member 11, for example, as shown in FIG. 3.

The method for connecting is not particularly limited and may be appropriately selected according to the purpose. It is easy to detach the edge guide 2 from and connect the edge guide to the fixing member 12 or the close contact member 11, when they have such a locking mechanism as shown in FIG. 3 and FIG. 4.

For moving the edge guide 2 integrally with the fixing member 12 and the close contact member 11, the member for moving the edge guide 2, the fixing member, and the close contact member outward from the discharging port width W may be replaced by a position adjusting mechanism for adjusting the position of the edge guide 2, while the coating liquid is discharged in a small amount (see FIG. 14).

On the other hand, for moving the edge guide 2 independently from the fixing member 12 and the contact member 11, the member for moving them is not particularly limited and may be appropriately selected.

As another method for moving them independently, the fixing member 12 or the close contact member 11 may be fixed at a position that is away from the coating portion of the sheet-shaped deckle 10 by larger than the width of the edge guide 2 by several millimeters to several ten millimeters, so that only the edge guide 2 may be moved in the width direction. This makes it possible to prevent the edge guide 2 from being contaminated while the coating liquid is discharged in a small amount. Because this makes a portion of the sheet 14 that is between the edge guide 2 and the fixing member 12 unable to be pressed during the coating, it is preferable to move the fixing member 12 or press the portion with a magnet or the like.

While the coating liquid is discharged in a small amount as shown in FIG. 13, and the edge guide 2, the fixing member 12, and the close contact member 11 are moved outward from the discharging port width W, a portion of the sheet 14 that is between the coating portion of the deckle 10 and the edge guide 2 cannot be pressed. Therefore, when there is a risk that the coating liquid may leak from the discharging port of the slot die 1 in the portion that cannot be pressed, it is possible to prevent the leakage with a magnet or the like.

Examples of the method for preventing liquid leakage from the portion that cannot be pressed include a method of using a rectangular neodymium magnet.

The mechanism for moving the edge guide 2 in the coating width direction is preferably different from a slide mechanism for sliding the edge guide 2 that is used for changing the coating width.

However, when the slide mechanism used for changing the coating width is also used as the moving mechanism, the necessary amount of slide is preferably from several millimeters to several ten millimeters. In this case, a positioning point may be provided, or alternatively, the moving amount or the target position to move to for changing the coating width may be used as the slide amount or the target position to slide to, although sliding takes some time.

During the coating, the discharging direction from the discharging port of the slot die 1 is the direction of gravitational force (downward).

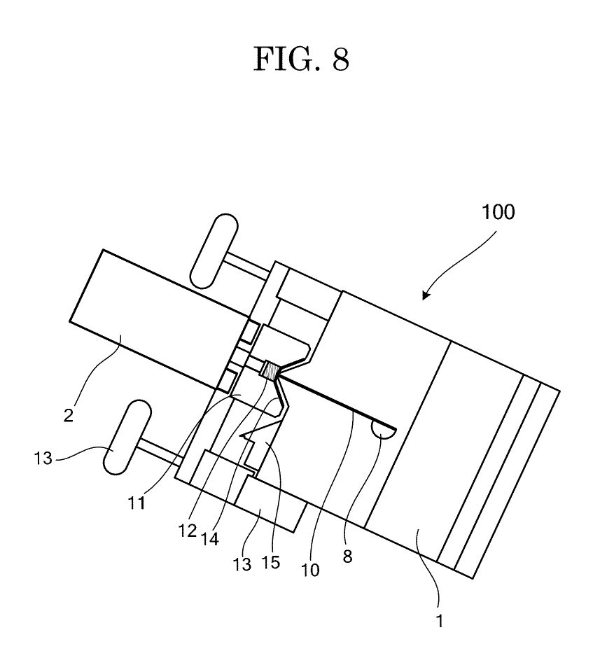

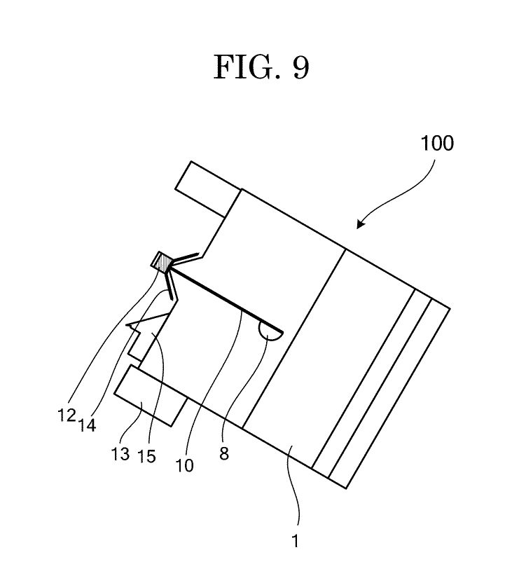

By inclining the discharging direction to which the coating liquid is discharged from the discharging port of the slot die 1 to a horizontal direction or to a direction opposite from the support member with respect to the horizontal direction as shown in FIG. 8 and FIG. 9, it is possible to make it easier for the sheet-shaped deckle 10 to be inserted into the slot die 1.

Further, also by inclining the discharging direction to which the coating liquid is discharged from the slot die 1 to a horizontal direction or to a direction opposite from the support member with respect to the horizontal direction, it is possible to obtain an effect of making it easier for air bubbles in the manifold of the slot die 1 to be removed, or for the slit and lip to be cleaned.

It is preferable that the discharging direction to which the coating liquid is discharged from the discharging port of the slot die 1 be inclined to a direction opposite from the support member by 0 degree to 60 degrees with respect to the horizontal direction, and more preferably by 5 degrees to 30 degrees with respect to the horizontal direction in terms of making it more secure for air bubbles to be deaerated, and making the deaeration time short.

In order to make it easier to change the curtain film coating width, to make it easier to clean the discharging port and slit of the slot die 1, and to prevent the edge guide 2 from being contaminated during the cleaning, it is preferable to detach the edge guide from the discharging port of the slot die.

When the discharging direction to which the coating liquid is discharged from the slot die 1 is inclined to a horizontal direction or to a direction opposite from the support member with respect to the horizontal direction, and liquid is discharged in a small amount during removal of air bubbles in the manifold of the slot die or during cleaning of the slit and lip, the discharged coating liquid and the cleaning liquid trickle down a downward surface and contaminate this surface, and the coating liquid spatters and falls in many directions, to unavoidably cause contamination by liquid spattering. Therefore, it is preferable to provide a flow down guide plate 15 on the slot die 1.

The flow down guide plate 15 is not particularly limited, and may be a detachable type or a fixed type.

The material of the flow down guide plate 15 is not particularly limited and may be appropriately selected according to the purpose. Examples thereof include: resins such as nylon, polypropylene, and polyethylene terephthalate (PET); and metal such as aluminum and stainless steel.

The width of the flow down guide plate 15 is not particularly limited and may be appropriately selected. However, it is preferably equal to or greater than the width of the discharging port of the slot die 1, and more preferably greater than the width of the discharging port of the slot die 1 by from 10 mm to 30 mm.

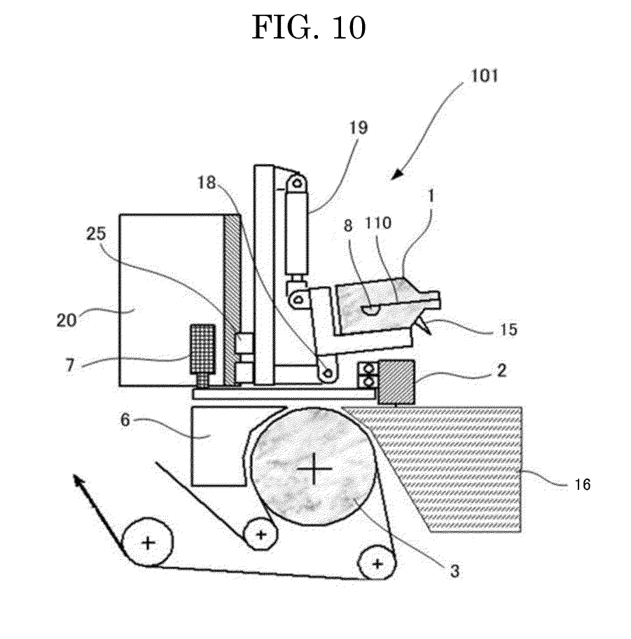

The length of the flow down guide plate 15 is not particularly limited and may be appropriately selected according to the purpose, as long as it is such a length as can guide the coating liquid into a liquid receptacle pan 16 (see FIG. 10).

The angle formed between a flow-down surface and a horizontal plane when the discharging direction to which the coating liquid is discharged from the discharging port of the slot die 1 is inclined to a direction opposite from the support member is preferably from 0° to 60°, and particularly preferably about 45° because the coating liquid would flow down smoothly. The lower edge of the flow down surface is not particularly limited and may be appropriately selected according to the purpose, as long as it has an acute angle.

It is preferable that the discharging port side of the flow down surface be close to the discharging port in order to prevent the slot die 1 from being contaminated. However, the distance from the discharging port side of the flow down surface to the discharging port is preferably 10 mm or greater in terms of work efficiency of cleaning the lip of the slot die 1.

Here, the flow-down surface means a coating-width-direction surface of the flow down guide plate 15 along which a coating liquid flows down.

When inclining the discharging direction to which the coating liquid is discharged from the slot die to a horizontal direction or to a direction opposite from the support member with respect to the horizontal direction, the edge guide may be pivoted integrally and simultaneously with, or independently from the slot die, or alternatively, only the slot die may be pivoted.

The height of the slot die 1 is not particularly limited and may be appropriately selected according to the purpose.

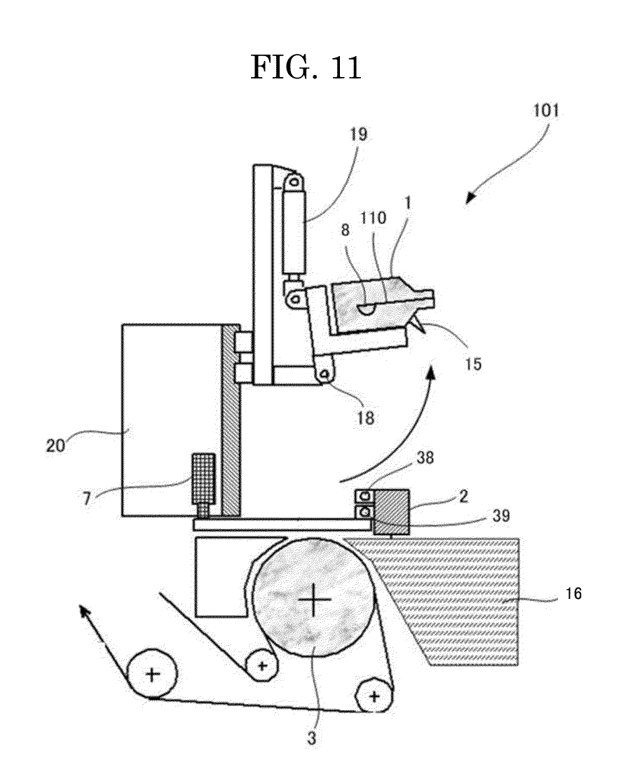

FIG. 10 and FIG. 11 are schematic diagrams showing an example mechanism for changing the height of the slot die. In FIG. 10 and FIG. 11, the reference sign 101 denotes the curtain coating machine, the reference sign 18 denotes the center of pivot, the reference sign 19 denotes a pivoting moment generating unit, the reference sign 6 denotes a vacuum chamber, the reference sign 7 denotes an edge guide lift up/down cylinder, the reference sign 16 denotes a liquid receptacle pan, the reference sign 20 denotes a coating head frame, the reference sign 3 denotes a backup roll, the reference sign 25 denotes a slide mechanism, the reference sign 38 denotes a front/rear slide unit, and the reference sign 39 denotes a left/right slide unit.

A preferable height of the slot die 1 varies depending on the operation. As for (1) human operator-related height, assumable cases are insertion of the deckle for changing the coating width, an operation for changing the coating width, and cleaning of the manifold of the slot die with a cleaning liquid that is not only performed by cleaning the slot from in front thereof but also by cleaning the manifold from the sides of the slot die. Therefore, the height of the slot die is preferably low, and more preferably about as high as the elbow of the human operator. For cleaning of the slot die for when only the coating liquid is discharged, the height of the slot die may be low or high. (2) Liquid spattering-related height is not particularly limited and may be appropriately selected according to the purpose. However, the vertical distance from the slot die to the liquid receptacle pan is preferably 300 mm.

The height of the slot die is preferably low, and the vertical distance from the slot die to the liquid receptacle pan is preferably small.

It is also possible to set the height of the slot die after it is pivoted low by setting the center of pivot of the slot die at an appropriate height. However, there are various constraints to the center position designing. Hence, by making the slot die movable up and down, it is possible to avoid constraints to the machine designing.

The curtain coating machine and the curtain coating method of the present invention have been explained in detail above. However, the present invention is not to be limited to the embodiments, and may be modified variously without departing from the scope of the spirit of the present invention.

### EXAMPLES

Examples of the present invention will be explained below. The present invention is not to be limited to these Examples by any means.

### Example 1

With the curtain coating machine shown in FIG. 2 to FIG. 7, the deckle 10 was inserted into the slit of the slot die 1, the discharging port of the slot die 1 was covered with the sheet 14 as the drop-off preventing member, the sheet 14 was pressed onto the discharging port of the slot die with the fixing member 12 and the close contact member 11, and curtain coating and changing of the curtain film coating width were performed.

In Example 1, the ratio (A/B)×100 was 90%, where A represented the thickness of the discharging width regulating member, and B represented the width of the discharging port of the curtain coating member.

In Example 1, the discharging port surface of the curtain coating member has a 2 mm flat portion. The length of the discharging port in the width direction was 600 mm.

The deckle 10 as the discharging width regulating member was a sheet-shaped member having a thickness of 0.488 mm and a length of 75 mm, and made of polyethylene terephthalate (PET).

The deckle 10 was inserted into both ends of the slot die 1 to regulate the coating width of the coating liquid to 450 mm from the width direction length of the discharging port of 600 mm.

The sheet 14 was a sheet having a thickness of 50 μm and a length of 30 cm and made of polyethylene terephthalate (PET).

The edge guide 2 as the guide member was the same as the edge guide described in JP-A No. 2012-35210.

The coating liquid was an acrylic emulsion adhesive [viscosity characteristic y=900x−0.26 (where x represented a shear rate (1/s), and y represented viscosity, and it was 700 mPa·s when measured with a B type viscometer), static surface tension of 30 mN/m, manufactured by Saiden Chemical Industry Co., Ltd.].

Next, liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 1.

### Example 2

Curtain coating and changing of the curtain film coating width were performed in the same manner as Example 1, except that the sheet 14 was pressed onto the discharging port of the slot die with the edge guide 2 and the close contact member (integrated with the fixing member) unlike Example 1. Liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 1.

### Comparative Example 1

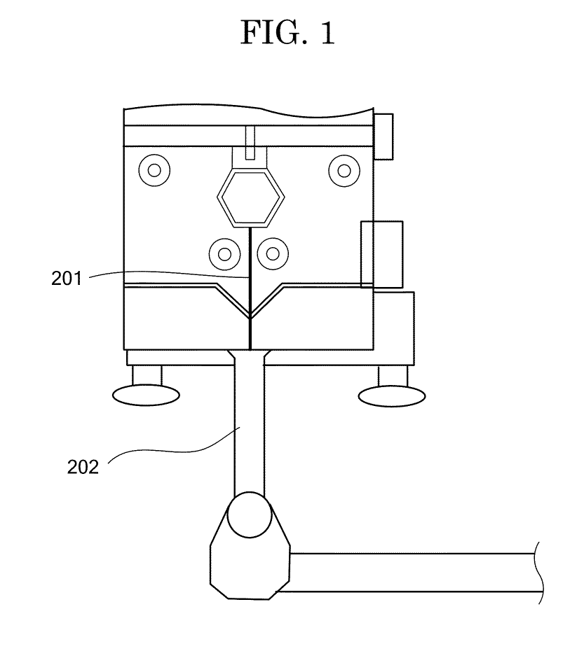

Curtain coating and changing of the curtain film coating width were performed in the same manner as Example 1, except that a curtain coating machine in which a deckle 201 and an edge guide 202 were integrated as shown in FIG. 1 was used. Liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 1.

### Comparative Example 2

Curtain coating and changing of the curtain film coating width were performed in the same manner as Example 1, except that the sheet 14 was not used unlike Example 1. Liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 1.

TABLE 1

| | | | Contamination of curtain film | |
|---|---|---|---|---|
| | Liquid leakage from | Easiness of | flow down surface of edge guide | |
| | discharging port in | coating width | During slit | Before coating |
| | non-coating portion | changing | cleaning | was started |
| Ex. 1 | Very little liquid leakage | Easily | Contamination | Contamination |
| | | changeable | absent | absent |
| Ex. 2 | Very little liquid leakage | Easily | Contamination | Contamination |
| | | changeable | absent | absent |
| Comp. | Very little liquid leakage | Easily | Contamination | Contamination |
| Ex. 1 | | changeable | present | present |
| Comp. | Liquid leaked and coating | Unchangeable | Contamination | Contamination |
| Ex. 2 | could not be performed | due to liquid | present | present |
| | | leakage | | |

From the results of Table 1, Examples 1 and 2 realized stable coating because during the coating, no or almost no coating liquid leaked from the discharging port of the slot die in the non-coating portion. Further, the edge guide was not contaminated during the cleaning of the slit or before the coating was started.

Comparative Example 1 realized easy coating width changing, but incurred contamination to the curtain film flow down surface of the edge guide with the spattering coating liquid, because the deckle and the edge guide were integrated and could not be separated to thereby leave the coating width regulated and the edge guide not retracted during the cleaning of the slit and before the coating was started.

Comparative Example 2 incurred liquid leakage from the non-coating portion during the coating, and necessitated suspension of the coating operation.

### Example 3

Curtain coating and changing of the curtain film coating width were performed in the same manner as Example 1, except that the ratio (A/B)×100 was set to 99% unlike Example 1. Liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 2.

### Example 4

Curtain coating and changing of the curtain film coating width were performed in the same manner as Example 1, except that the ratio (A/B)×100 was set to 80% unlike Example 1. Liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 2.

### Example 5

Curtain coating and changing of the curtain film coating width were performed in the same manner as Example 1, except that the discharging port surface of the curtain coating member had a 0.5 mm flat portion unlike Example 1. Liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 2.

### Example 6

Curtain coating and changing of the curtain film coating width were performed in the same manner as Example 1, except that a sheet having a thickness of 20 μm and a length of 30 cm and made of polyethylene terephthalate (PET) was used as the sheet 14 as the drop-off preventing member unlike Example 1. Liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 2.

### Example 7

Curtain coating and changing of the curtain film coating width were performed in the same manner as Example 1, except that a sheet having a thickness of 250 μm and a length of 30 cm and made of polyethylene terephthalate (PET) was used as the sheet 14 as the drop-off preventing member unlike Example 1. Liquid leakage from the discharging port of the slot die, easiness of coating width changing, and contamination state of the curtain film flow down surface of the edge guide when curtain coating and changing of the curtain film coating width were performed with the curtain coating machine of Example 1 were evaluated. The results are shown in Table 2.

TABLE 2

| | Liquid leakage | |
|---|---|---|
| | from discharging | |
| | port in non-coating portion | Easiness of coating width changing |
| Ex. 1 | Very little liquid leakage | Coating width was easily changeable |
| Ex. 3 | Very little liquid leakage | Took some time to insert deckle |
| Ex. 4 | Slight liquid leakage | Coating width was easily changeable |
| Ex. 5 | Slight liquid leakage | Took some time to fix fixing member |
| Ex. 6 | Very little liquid leakage | took some time to handle sheet |
| Ex. 7 | Slight liquid leakage | Coating width was easily changeable |

From the results of Table 2, in Example 1, no liquid leakage occurred from the non-coating portion, and the deckle was easy to move for changing the coating width.

In Example 3, no liquid leakage occurred from the non-coating portion, and it took some time to insert the deckle into the slot die for changing the coating width. Although this would be practically non-problematic in an actual operation, it was revealed that deckle insertion would be easier if the thickness of the deckle satisfied the ratio (A/B)×100 of 95% or less.

In Example 4, slight liquid leakage occurred from the non-coating portion, but this would be non-problematic in an actual operation and practically non-problematic. However, it was revealed that it would be preferable if the thickness of the deckle satisfied the ratio (A/B)×100 of 80% or greater.

In Example 5, slight liquid leakage occurred, and it took some time to fix the fixing member. This was considered due to that the flat portion of the discharging port surface of the slot die had a small area to thereby make it harder for the fixing member to be fixed. However, the liquid leakage was of a non-problematic level, and was not particularly problematic in an operation in which the coating width was frequently changed.

In Example 6, no liquid leakage occurred, but it took some time to handle the sheet because the sheet was thin. However, this was non-problematic unless in an operation in which the width would be changed frequently.

In Example 7, slight liquid leakage occurred, but coating width changing could be performed without any problem. The liquid leakage was of a non-problematic level in an actual operation. From this fact, it was revealed that the thickness of the sheet would preferably be 25 μm or greater, and the thickness of the sheet would appropriately be up to about 200 μm.

The curtain coating machine and the curtain coating method of the present invention are preferably used for manufacturing, for example, silver halide photographic sensitive material, magnetic recording material, pressure-sensitive recording paper, thermosensitive recording paper, adhesive label, art paper, coat paper, and inkjet recording sheet.

Aspects of the present invention are as follows, for example.

<1> A curtain coating machine, including:

a curtain coating member including a discharging port from which a coating liquid is discharged in a curtain shape;

a discharging width regulating member provided in the discharging port and configured to regulate a discharging width of the coating liquid to be discharged in a curtain shape;

a drop-off preventing member configured to prevent the discharging width regulating member from dropping off from the discharging port;

a fixing member configured to fix the drop-off preventing member; a close contact member provided movably on the fixing member, and configured to closely contact the drop-off preventing member, and via the drop-off preventing member, prevent the coating liquid from leaking in a discharging direction from a region in the discharging port where the discharging width regulating member is provided; and

a guide member provided detachably on the fixing member and configured to guide width-direction both edges of the coating liquid discharged from the discharging port in a curtain shape.

<2> The curtain coating machine according to <1>,

wherein the guide member is provided movably on a leading end portion of the close contact member.

<3> The curtain coating machine according to <1> or <2>,

wherein the curtain coating machine satisfies the following formula of 85%≦(A/B)×100≦95%, where A represents thickness of the discharging width regulating member, and B represents width of the discharging port of the curtain coating member.

<4> The curtain coating machine according to any one of <1> to <3>,

wherein both ends of the drop-off preventing member curve toward a manifold of the curtain coating member.

<5> The curtain coating machine according to any one of <1> to <4>,

wherein the drop-off preventing member is a sheet, and the sheet has a thickness of 25 μm or greater.

<6> The curtain coating machine according to any one of <1> to <5>,

wherein the close contact member and the fixing member are integrated as one member.

<7> A curtain coating method, including

performing curtain coating with the curtain coating machine according to any one of <1> to <6>.

### REFERENCE SINGS LIST

1 slot die
1a discharging port
2 edge guide
4 support member
5 curtain film
10 deckle
11 close contact member
12 fixing member
14 sheet
100 curtain coating machine
101 curtain coating machine
110 slit

1. A curtain coating machine, comprising:
a curtain coating member that comprises a discharging port from which a coating liquid is discharged in a curtain shape;
a discharging width regulating member provided in the discharging port and configured to regulate a discharging width of the coating liquid to be discharged in a curtain shape;
a drop-off preventing member configured to prevent the discharging width regulating member from dropping off from the discharging port;
a fixing member configured to fix the drop-off preventing member;
a close contact member provided movably on the fixing member and configured to closely contact the drop-off preventing member, and via the drop-off preventing member, prevent the coating liquid from leaking in a discharging direction from a region in the discharging port where the discharging width regulating member is provided; and
a guide member provided detachably on the fixing member and configured to guide width-direction both edges of the coating liquid discharged from the discharging port in a curtain shape.

2. The curtain coating machine according to claim 1,
wherein the guide member is provided movably on a leading end portion of the close contact member.

3. The curtain coating machine according to claim 1,
wherein the curtain coating machine satisfies the following formula of 85%≦(A/B)×100≦95%, where A represents thickness of the discharging width regulating member, and B represents width of the discharging port of the curtain coating member.

4. The curtain coating machine according to claim 1,
wherein both ends of the drop-off preventing member curve toward a manifold of the curtain coating member.

5. The curtain coating machine according to claim 1,
wherein the drop-off preventing member is a sheet, and the sheet has a thickness of 25 μm or greater.

6. The curtain coating machine according to claim 1,
wherein the close contact member and the fixing member are integrated as one member.

7. A curtain coating method, comprising:
performing curtain coating with the curtain coating machine comprising:
a curtain coating member that comprises a discharging port from which a coating liquid is discharged in a curtain shape;
a discharging width regulating member provided in the discharging port and configured to regulate a discharging width of the coating liquid to be discharged in a curtain shape;
a drop-off preventing member configured to prevent the discharging width regulating member from dropping off from the discharging port;
a fixing member configured to fix the drop-off preventing member;
a close contact member provided movably on the fixing member and configured to closely contact the drop-off preventing member, and via the drop-off preventing member, prevent the coating liquid from leaking in a discharging direction from a region in the discharging port where the discharging width regulating member is provided; and
a guide member provided detachably on the fixing member and configured to guide width-direction both edges of the coating liquid discharge from the discharging port in a curtain shape.
